(19) United States
(12) Patent Application Publication
(10) Pub. No.: US 2017/0245070 A1
(43) Pub. Date: Aug. 24, 2017

(54) VIBRATION SIGNAL GENERATION APPARATUS AND VIBRATION SIGNAL GENERATION METHOD

(71) Applicant: PIONEER CORPORATION, Tokyo (JP)

(72) Inventors: Katsutoshi INAGAKI, Kanagawa (JP); Makoto MATSUMARU, Kanagawa (JP); Tsutomu TAKAHASHI, Kanagawa (JP); Hiroshi IWAMURA, Kanagawa (JP); Kensaku OBATA, Kanagawa (JP); Hiroya NISHIMURA, Kanagawa (JP)

(21) Appl. No.: 15/503,534

(22) PCT Filed: Aug. 22, 2014
(86) PCT No.: PCT/JP2014/071992

§ 371 Date: Feb. 13, 2017

(51) Int. Cl. H04R 29/00; H04R 3/04; G10L 25/18; G10H 1/40

(52) U.S. Cl. CPC H04R 29/00; G10H 1/40; H04R 3/04; G10L 25/18; G10H 2210/076; G10H 2210/381

(57) ABSTRACT

A derivation unit (240) determines, as a specified rhythm component of a musical piece, a rhythm component detected within a predetermined time range including a time of reception of tap timing information TAP and derives a first frequency band the spectrum intensity of which is equal to or greater than a predetermined value. The derivation unit (240) also determines, as an unspecified rhythm component, a rhythm component detected outside the predetermined time range including the time of reception of the tap timing information TAP and derives a second frequency band the spectrum intensity of which is equal to or greater than the predetermined value. Thereafter, a calculation unit (250) calculates a third frequency band, which is included in the first frequency band and which does not include the second frequency band, and then transmits, to a filter unit (260), a passed-frequency designation BPC that designates the third frequency band. The filter unit (260) then subjects a musical piece signal MUD to a filtering process using the designated frequencies as a signal pass band. Subsequently, a vibration signal generation unit (270) generates a vibration signal VIS on the basis of a signal FTD having passed through the filter unit (260).

### TECHNICAL FIELD

The present invention relates to a vibration signal generation apparatus, to a vibration signal generation method, to a vibration signal generation program, and to a recording medium upon which such a vibration signal generation program is recorded.

### BACKGROUND ART

From the past, as a method of enjoying the sound of a piece of music, listening to the sound of the musical piece by replaying the contents of the musical piece has been widely performed by users. And, in recent years, the methods of enjoying the sound of a musical piece in order for the user to obtain a sense of unity of the sound of the musical piece have been diversified by vibrating a vibration unit together with the sound of the musical piece so that the user is caused to feel the sound of the musical piece due to this vibration, or by blinking a light together with the sound of the musical piece, or by making a character perform some action together with the sound of the musical piece or the like.

Here, as one technique for causing a vibration unit to vibrate together with the sound of a musical piece, a technique for causing a transducer to vibrate together with the appearance of a beat component of the musical piece has been proposed (refer to Patent Document #1, hereinafter termed “prior art #1”). With the technique according to the prior art #1, a beat component of the audio signal is extracted from a spectrogram of the sound of the musical piece, and the peak value of the time differential of the spectrum at the timing of the beat is acquired as information about the vibration intensity applied to the transducer. And an excitation signal is generated at the abovementioned timing of the beat, having a waveform that vibrates at an amplitude corresponding to this vibration intensity, and it is arranged to make the transducer vibrate according to this excitation signal.

Moreover, as another technique for causing a vibration unit to vibrate together with the sound of a musical piece, a technique for causing a transducer to vibrate together with the appearance of a specific musical instrument sound component of the music has been proposed (refer to Patent Document #2, hereinafter termed “prior art #2”). With the technique according to the prior art #2, sound data corresponding to the sound range of the reproduced sound of that musical instrument is extracted by a band pass filter that is defined for each musical instrument such as a bass or a drum or the like, and drive pulses of a predetermined frequency are generated during intervals in which this sound data is equal to or greater than a predetermined level. And the transducer is caused to resonate by these drive pulses, so that vibrations corresponding to the reproduced sound are generated.

### PRIOR ART DOCUMENT

### Patent Documents

Patent Document #1: Japanese Laid-Open Patent Publication 2008-283305.

Patent Document #2: Japanese Laid-Open Patent Publication 2013-56309.

### SUMMARY OF THE INVENTION

### Problem to be Solved by the Invention

With the technique described in the above prior art #1, the transducer is caused to vibrate in correspondence with a beat component of the sound of the musical piece that has been extracted, and at an amplitude intensity that corresponds to the intensity of that beat component. Due to this, to a user who is sensitive to beat sound, it is possible to impart a sense of unity between the vibrations and the sound of the musical piece. However, the way in which the overall unity between the shaking produced due to the application of such vibrations and the sound of a musical piece is experienced varies depending upon the user. Accordingly when, as with the technique described in the above prior art #1, vibrations are imparted in accordance with the vibrations of a beat component of the sound of a musical piece, there may be some users who are not capable of experiencing a sense of unity between the vibrations and the sound of the musical piece.

Furthermore, with the technique described in the above prior art #2, the transducer is caused to vibrate in correspondence with a sound component of a musical instrument such as a bass or a drum in the sound of the musical piece. Due to this, it is possible for a user who is sensitive to the sound of a musical instrument such as a bass or a drum to experience a sense of unity between the vibrations and the sound of the musical piece, but, for a user who is not thus sensitive, in some cases it may happen that he is not able to experience a sense of unity between the vibrations and the sound of the musical piece.

Therefore, since the ways in which the overall nature of the shaking due to the impartation of vibrations and the sound of the musical piece are experienced vary between different individuals. Accordingly, with the techniques of the prior art #1 and the prior art #2, there are some users who are not able to experience a sense of unity between the vibration and the sound of the musical piece.

Due to this, there is a demand for a technique that is capable of generating vibrations according to the progression of the sound of a musical piece, these vibrations being matched in a unified manner to the way in which the sound of the musical piece is experienced by each individual user, so as to impart to each user a sense of unity between the vibrations and the sound of the musical piece. To respond to such a demand is considered to be one of the problems that the present invention can solve.

### Means for Solving the Problems

The invention of Claim 1 is a vibration signal generation apparatus, comprising: a detection unit that detects a rhythm of a musical piece; a reception unit that receives input of timing information from a user; and a generation unit that generates a vibration signal for causing a vibration unit to vibrate, on the basis of the rhythm detected by said detection unit and the timing information received by said reception unit.

And the invention of Claim 9 is a vibration signal generation method that is employed by a vibration signal generation apparatus that generates a vibration signal, comprising the steps of: a detection step of detecting a rhythm of a musical piece; a reception step of receiving input of timing information from a user; and a generation process of generating a vibration signal for causing a vibration unit to vibrate, on the basis of the rhythm detected by said detection process and the timing information received by said reception process.

And the invention of Claim 10 is a vibration signal generation program, wherein, a computer included in a vibration signal generation apparatus to execute a vibration signal generation method according to Claim 9.

And the invention of Claim 11 is a recording medium, wherein, a vibration signal generation program according to Claim 10 is recorded thereupon in a form that can be read by a computer in a vibration signal generation apparatus.

### BRIEF DESCRIPTION OF DRAWINGS

FIG. 1 is a schematic figure showing the configuration of a sound device that is provided with a vibration signal generation apparatus according to an embodiment of the present invention;

FIG. 2 is a figure for explanation of the way in which audio output units (i.e. speakers) and vibration units (i.e. vibrators) of FIG. 1 are arranged;

FIG. 3 is a figure for explanation of the configuration of the vibration signal generation apparatus of FIG. 1;

FIG. 4 is a flow chart for explanation of vibration signal generation processing by the vibration signal generation apparatus of FIG. 3;

FIG. 5 is a flow chart for explanation of processing in FIG. 4 for derivation of the first frequency band and the second frequency band;

FIG. 6 is the first figure in which an example of a relationship between the appearance of a rhythm component and tapping timing, and the third frequency band that has been calculated on the basis of that relationship, are shown together;

FIG. 7 is the second figure in which an example of a relationship between the appearance of a rhythm component and tapping timing, and the third frequency band that has been calculated on the basis of that relationship, are shown together;

FIG. 8 is the third figure in which an example of a relationship between the appearance of a rhythm component and tapping timing, and the third frequency band that has been calculated on the basis of that relationship, are shown together;

FIG. 9 is the fourth figure in which an example of a relationship between the appearance of a rhythm component and tapping timing, and the third frequency band that has been calculated on the basis of that relationship, are shown together;

FIG. 10 is the fifth figure in which an example of a relationship between the appearance of a rhythm component and tapping timing, and the third frequency band that has been calculated on the basis of that relationship, are shown together;

FIG. 11 is a figure for explanation of a modified embodiment; and

FIG. 12 is a figure for explanation of a modified embodiment for the positions in which the audio output units (i.e. the speakers) and the vibration units (i.e. the vibrators) may be arranged.

### REFERENCE SIGNS LIST

130: vibration signal generation apparatus
210: tapping input unit (a portion of the reception unit)
220: reception period setting unit (a portion of the reception unit)
230: detection unit
240: derivation unit (a portion of the generation unit)
250: calculation unit (a portion of the generation unit)
260: filter unit (a portion of the generation unit)
270: vibration signal generating unit (a portion of the generation unit)
400: vibration unit

### EMBODIMENTS FOR CARRYING OUT THE INVENTION

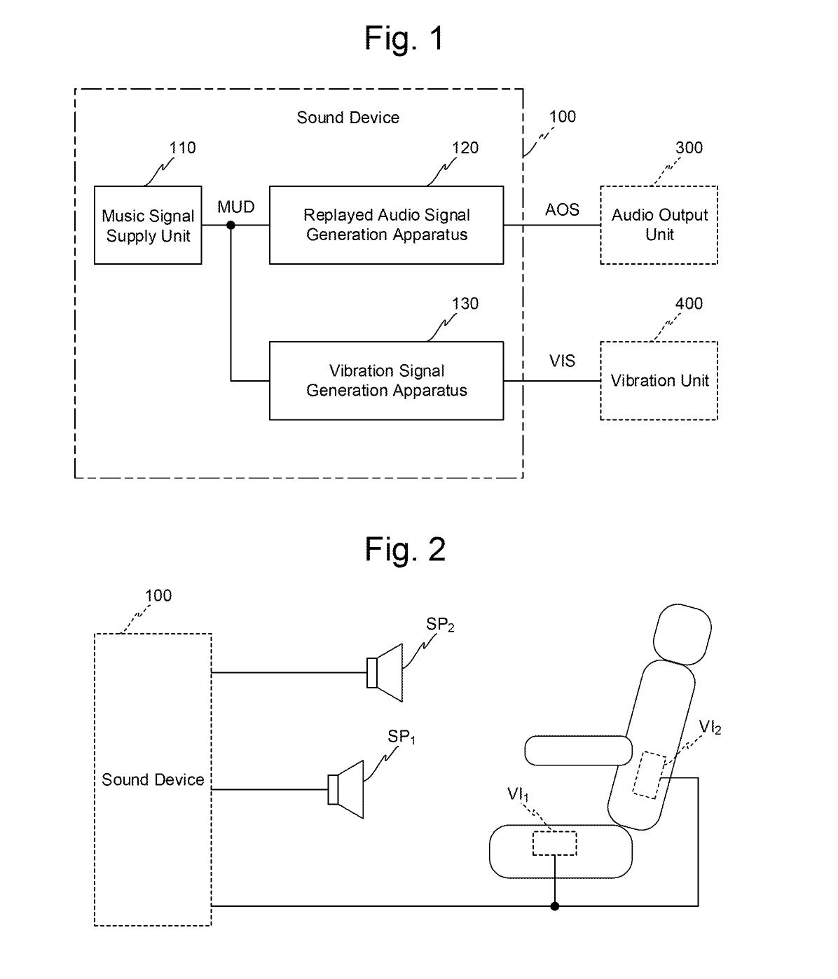

An embodiment of the present invention will now be explained with reference to FIGS. 1 through 10. Note that, in the following explanation and drawings, the same reference symbol is appended to elements that are the same or equivalent, and duplicated explanation will be omitted.

### [Configuration]

The schematic configuration of a sound device 100 that is provided with a “vibration signal generation apparatus” according to an embodiment of the present invention is shown in FIG. 1 as a block diagram. In this embodiment, an audio output unit 300 and a vibration unit 400 are connected to the sound device 100.

The audio output unit 300 is configured to comprise speakers SP₁ and SP₂. The audio output unit 300 receives a replay audio signal AOS sent from the sound device 100. And the audio output unit 300 outputs the sound of a musical piece (i.e. replayed audio) from the speakers SP₁ and SP₂ according to the replay audio signal AOS.

The vibration unit 400 is configured to comprise vibrators VI₁ and VI₂. The vibration unit 400 receives a vibration signal VIS sent from the sound device 100 (in more detail, from the vibration signal generation apparatus). And the vibration unit 400 causes the vibrators VI₁ and VI₂ to vibrate according to this vibration signal VIS.

The way in which, in this embodiment, the speakers SP₁ and SP₂ and the vibrators VI₁ and VI₂ are arranged is shown in FIG. 2. The speakers SP₁ and SP₂ may, for example, be arranged in front of a chair in which the user sits. And, as shown in FIG. 2, the vibrator VI₁ is disposed in the interior of a seat portion of the chair. Thus, this seat portion is caused to vibrate when the vibrator VI₁ vibrates. Moreover, the vibrator VI₂ is disposed in the interior of a backrest portion of the chair. Thus, this backrest portion is caused to vibrate when the vibrator VI₂ vibrates.

Next, the configuration of the sound device 100 described above will be explained.

As shown in FIG. 1, the sound device 100 comprises a music signal supply unit 110, a replayed audio signal generation apparatus 120, and a vibration signal generation apparatus 130.

The music signal supply unit 110 generates a music signal on the basis of musical piece contents data. The music signal MUD that has been generated in this manner is sent to the replay audio signal generation apparatus 120 and to the vibration signal generation apparatus 130.

The replayed audio signal generation apparatus 120 is built to comprise an input unit, a digital processing unit, an analog processing unit and so on, none of these being shown in the figures.

The input unit is built to comprise a key unit that is provided to the replayed audio signal generation apparatus 120, and/or a remote input device that is provided with a key unit or the like. Settings and/or operational commands related to the details of operation of the replayed audio signal generation apparatus 120 are issued by the user actuating this input unit. For example, the user may issue a replay command for the contents of a musical piece or the like by using the input unit.

The digital processing unit receives the music signal MUD sent from the music signal supply unit 110. And the digital processing unit performs predetermined processing upon this music signal, and generates a digital audio signal. The digital audio signal that has been generated in this manner is sent to the analog processing unit.

The analog processing unit is built to comprise a digital/analog conversion unit and a power amplification unit. The analog processing unit receives the digital audio signal sent from the digital processing unit. And, after having converted this digital audio signal into an analog signal, the analog processing unit power amplifies this analog signal, thus generating a replayed audio signal AOS. The replayed audio signal AOS that has been generated in this manner is sent to the audio output unit 300.

### <Configuration of the Vibration Signal Generation Apparatus 130>

Next, the configuration of the vibration signal generation apparatus 130 will be explained.

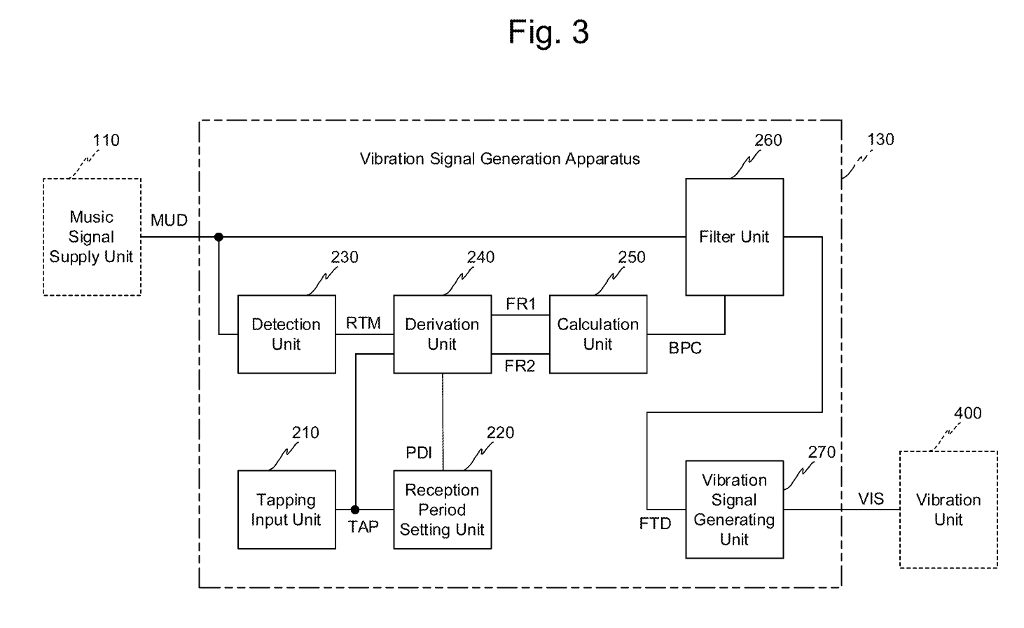

As shown in FIG. 3, this vibration signal generation apparatus 130 comprises a tapping input unit 210, a reception period setting unit 220, and a detection unit 230. Moreover, the vibration signal generating unit 130 comprises a derivation unit 240, a calculation unit 250, a filter unit 260, and a vibration signal generation unit 270.

The tapping input unit 210 is built to comprise a tapping input switch and so on. This tapping input unit 210 receives tapping action by the user. And, when tapping action by the user is received, the tapping input unit 210 creates tapping timing information TAP related to that tapping operation, and sends it to the reception period setting unit 220 and to the derivation unit 240. Note that, the tapping input unit 210 is adapted to serve the function of a portion of the abovementioned reception unit.

In this embodiment, the reception period setting unit 220 is endowed with an internal timer function. When tapping timing information TAP sent from the tapping input unit 210 is received during an interval other than a reception period, the reception period setting unit 220 starts a reception period. And the reception period setting unit 220 generates period information PDI specifying that the present time point is a reception period, and sends this period information PDI to the derivation unit 240. Thereafter, when this reception period terminates, the reception period setting unit 220 generates period information PDI specifying that this is no longer a reception period, and sends this period information PDI to the derivation unit 240.

Furthermore, when tapping timing information TAP is received from the tapping input unit 210 after a predetermined time period has elapsed from the end of the reception period, the reception period setting unit 220 starts a new reception period. And the reception period setting unit 220 generates period information PDI specifying that this is a reception period, and sends it to the derivation unit 240.

Here, the “reception period” is set in advance on the basis of experiment, simulation, experience or the like, from the standpoint of determining upon a rhythm component that agrees with the user's sense of rhythm. Moreover, the “predetermined time period” is set in advance on the basis of experiment, simulation, experience or the like, in consideration of the fact that there is a possibility that the rhythm that accords with the user's sense of rhythm may change according to the progression of the musical piece. Or, it would also be acceptable to calculate the “reception period” and the “predetermined time period” from a musical piece tempo BPM that is obtained by analyzing the musical piece. This musical piece tempo BPM represents beats per minute, i.e. is a value that specifies the number of music beats in one minute. For example, the “reception period” may be set to 4×(60÷the musical piece tempo BPM) seconds, the “predetermined time period” may be set to 12×(60÷the musical piece tempo BPM) seconds, and so on.

Note that, the reception period setting unit 220 is adapted to fulfil the function of a portion of the reception unit.

The detection unit 230 receives the music signal MUD sent from the music signal supply unit 110. And the detection unit 230 analyzes this music signal MUD, and acquires therefrom spectrogram information that specifies change of the frequency characteristic of the musical piece. Subsequently, on the basis of this spectrogram information, the detection unit 230 detects the time zone at which the spectral intensity at any frequency in a predetermined frequency range becomes equal to or greater than a predetermined value, as being the time zone of appearance of the “rhythm” component. And the detection unit 230 generates rhythm information RTM that includes both the time zone of appearance of the “rhythm” component that has been detected and its spectral intensity in that time zone of appearance, and sends this rhythm information RTM to the derivation unit 240.

Here, “rhythm” is a fundamental element of the sound of a musical piece, reflecting its beat, its sound fluctuation, and so on, and refers to the sound progression over time.

Note that, the “predetermined frequency range” and the “predetermined value of the spectral intensity” are set in advance on the basis of experiment, simulation, experience, and the like, from the standpoint of effectively detecting the rhythm of the musical piece. For example, a range of musical instrument sounds such as bass or drum or the like may be included as the “predetermined frequency range”, while not including the sound range of vocal sound. Furthermore, the “predetermined value of the spectral intensity” may be calculated from the average value of the spectral intensity of the musical piece, or from the value of its variance or the like.

The derivation unit 240 receives the period information PDI sent from the reception period setting unit 220. And, when the content of the period information PDI indicates that this is a reception period, the derivation unit 240 sets an interval flag to “ON”; while, when the content of the period information PDI indicates that this is not a reception period, the derivation unit 240 sets an interval flag to “OFF”.

Moreover, the derivation unit 240 receives the tapping timing information TAP sent from the tapping input unit 210. Furthermore, the derivation unit 240 receives the rhythm information RTM sent from the detection unit 230. And, when the period flag is “ON”, on the basis of the tapping timing information TAP and the rhythm information RTM, the derivation unit 240 determines a rhythm component detected within a predetermined time range that includes the time of reception of the tapping timing information TAP as being the characteristic rhythm component of the musical piece. Subsequently, on the basis of the rhythm information for this characteristic rhythm component, the derivation unit 240 derives the first frequency band for which the spectral intensity in the time zone of appearance of that characteristic rhythm is equal to or greater than the predetermined value.

Furthermore, when the period flag is “ON”, on the basis of the tapping timing information TAP and the rhythm information RTM, the derivation unit 240 determines a rhythm component detected outside the predetermined time range that includes the time of reception of the tapping timing information TAP as being a non-characteristic rhythm component. And, on the basis of the rhythm information for this non-characteristic rhythm component, the derivation unit 240 derives the second frequency band for which the spectral intensity in the time zone of appearance of this non-characteristic rhythm is equal to or greater than the predetermined value. The first frequency band and the second frequency band that have been derived in this manner are respectively taken as the first frequency band information FR1 and the second frequency band information FR2, and are sent to the calculation unit 250.

Here, the “predetermined time range” is set in advance on the basis of experiment, simulation, experience, and the like, in consideration of the fact that, precisely, there is a time difference between the time point at which the user inputs tapping and the time point of appearance of the characteristic rhythm component, and from the standpoint of it being possible to evaluate that the rhythm component corresponding to tapping input is the characteristic rhythm component. Alternatively, it would be possible to calculate the predetermined time range from the musical piece tempo BPM that is obtained by analyzing the musical piece. In concrete terms, the predetermined time range is set to be longer if the musical piece tempo BPM is slow, and is set to be shorter if the musical piece tempo BPM is fast.

The details of the processing performed by the derivation unit 240 will be described hereinafter. Note that, the derivation unit 240 is adapted to fulfil the function of a portion of the generation unit.

The calculation unit 250 receives the first frequency band information FR1 and the second frequency band information FR2 sent from the derivation unit 240. And, upon receipt of the first frequency band information FR1 and the second frequency band information FR2, the calculation unit 250 calculates the frequency band in the first frequency band, in which the second frequency band is not included, as being the third frequency band. Subsequently, the calculation unit 250 sends, to the filter unit 260, a pass frequency designation BPC that specifies this third frequency band that has thus been calculated.

The details of the calculation processing performed by the calculation unit 250 for deriving the third frequency band will be described hereinafter. Note that, the calculation unit 250 is adapted to serve the function of a portion of the generation unit.

The filter unit 260 is built as a variable filter. This filter unit 260 receives the music signal MUD sent from the music signal supply unit 110. Moreover, the filter unit 260 receives the pass frequency designation BPC sent from the calculation unit 250. And the filter unit 260 performs filtering processing upon the music signal MUD, while taking the frequencies designated in the pass frequency designation BPC as a signal pass band. The result of this filtering processing is sent to the vibration signal generation unit 270 as a signal FTD.

The vibration signal generation unit 270 receives the signal FTD sent from the filter unit 260. And the vibration signal generation unit 270 generates the vibration signal VIS reflecting the frequency and the amplitude that are contained in that signal FTD.

When generating the above vibration signal VIS, the vibration signal generation unit 270 is adapted, on the basis of the response characteristics of the vibrators VI₁ and VI₂, to convert high frequency components of the signal FTD for which the above response characteristic is greatly attenuated into vibration signals at frequencies at which the response characteristics of the vibrators VI₁ and VI₂ are not greatly attenuated. This conversion processing may, for example, be done by performing a fast Fourier transform upon the signal FTD, and by frequency converting the spectral intensities at each frequency into low frequencies at which the response characteristics of the vibrators VI₁ and VI₂ are not greatly attenuated. And the vibration signal VIS based upon which the vibrators VI₁ and VI₂ are capable of vibrating is generated by performing an inverse fast Fourier transform upon the above signal that has thus been frequency converted. The vibration signal VIS that has been generated in this manner is sent to the vibration unit 400.

Note that, the filter unit 260 and the vibration signal generation unit 270 are adapted to fulfil the function of a portion of the generation unit.

### [Operation]

The operation of the sound device 100 having a configuration such as described above will now be explained, with attention being principally directed at the processing performed by the vibration signal generation apparatus 130 for generating the vibration signal.

As preliminaries, it will be supposed that a user sits in the chair shown in FIG. 2, and that, in the sound device 100, the music signal supply unit 110 supplies a music signal MUD to the replayed audio signal generation apparatus 120 and to the vibration signal generation apparatus 130. And it will be supposed that, in the replayed audio signal generation apparatus 120, the digital processing unit and the analog processing unit are performing replayed audio processing upon the music signal MUD, and are generating the replayed audio signal AOS and are outputting it to the audio output unit 300. And it will be supposed that, as a result, the sound of the musical piece is being outputted from the speakers SP₁ and SP₂.

Furthermore it will be supposed that, in the vibration signal generation apparatus 130, the detection unit 230 is acquiring spectrogram information by analyzing the music signal MUD, and that, in a predetermined frequency range, the time zone in which the spectral intensity becomes equal to or greater than the predetermined value is being detected as the time zone of appearance of a “rhythm” component. And it will be supposed that, when the detection unit 230 generates rhythm information RTM related to this rhythm component that has been detected, this rhythm information is sequentially sent to the derivation unit 240. Yet further it will be supposed that, in the vibration signal generation apparatus 130, the filter unit 260 is receiving the music signal MUD sent from the music signal supply unit 110.

It should also be supposed that, initially, the period flag is set to “OFF”. Moreover it will be supposed that, initially, the filter unit 260 is set so as not to allow any component of the music signal MUD in any frequency range to pass through. Due to this it will be supposed that, initially, the seat portion of the chair in which the vibrator VI₁ is disposed and the backrest portion of the chair in which the vibrator VI₂ is disposed are not vibrating.

Moreover it will be supposed that, when tapping input by the user is being performed upon the tapping input unit 210, a rhythm component is detected within the predetermined time range that includes the time of reception of this tapping input.

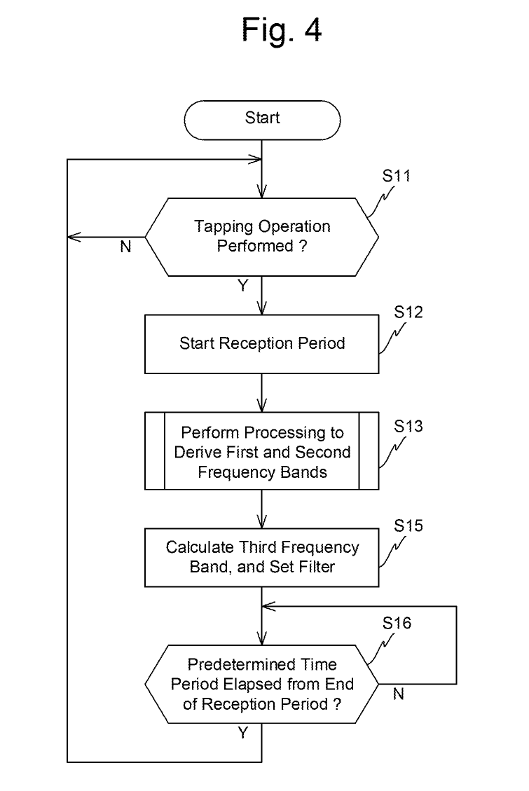

Based upon this type of situation, as shown in FIG. 4, first in a step S11 the reception period setting unit 220 of the vibration signal generation apparatus 130 makes a decision as to whether or not tapping operation has been performed by the user, in other words as to whether or not tapping timing information TAP sent from the tapping input unit 210 has been received. If the result of the decision is negative (N in the step S11), then the processing of the step S11 is repeated.

When, during this repetition of the processing of the step S11, the reception period setting unit 220 receives tapping timing information TAP so that the result of the decision in the step S11 becomes affirmative (Y in the step S11), then the flow of control proceeds to a step S12. In the step S12, the reception period setting unit 220 starts a reception period, and generates period information PDI to the effect that this is a current reception period and sends this period information PDI to the derivation unit 240. When the period information PDI is sent in this manner, the derivation unit 240 sets the period flag to “ON”. Then the flow of control proceeds to a step S13.

In the step S13, processing for derivation of the first and second frequency bands is performed. The details of this processing in the step S13 will be described hereinafter. And, when the processing of the step S13 has been completed, the flow of control proceeds to a step S15.

In the step S15, on the basis of the frequency band information sent from the derivation unit 240, the calculation unit 250 calculates a frequency band within the first frequency band in which the second frequency band is not included as being the third frequency band. Here, if no such the second frequency band exists, then the calculation unit 250 takes the first frequency band as being the third frequency band. Subsequently, the calculation unit 250 sends a pass frequency designation BPC that designates the third frequency band to the filter unit 260.

When the pass frequency designation BPC that sets the third frequency band is provided to the filter unit 260 in this manner, the filter unit 260 performs filtering processing upon the music signal MUD while taking the frequencies designated by the above pass frequency designation BPC as being the signal pass band. And the filter unit 260 sends the result of this filtering processing to the vibration signal generation unit 270 as the signal FTD.

Upon receipt of the signal FTD that has passed through the filter unit 260, on the basis of that signal FTD, the vibration signal generation unit 270 generates the vibration signal VIS that reflects the frequency and the amplitude of the signal FTD. And the vibration signal generation unit 270 sends this vibration signal VIS that has thus been generated to the vibration unit 400.

Upon receipt of this vibration signal VIS, the vibrators VI₁ and VI₂ of the vibration unit 400 are caused to vibrate according to the vibration signal VIS. As a result, the seat portion of the chair in which the vibrator VI₁ is disposed and the backrest portion of the chair in which the vibrator VI₂ is disposed both vibrate.

Subsequently, in a step S16 the reception period setting unit 220 makes a decision as to whether or not the predetermined time period has elapsed from the end of the reception period. If the result of the decision is negative (N in the step S16), the processing of the step S16 is repeated. And, when the predetermined time period from the end of the reception period elapses and the result of the decision in the step S16 becomes affirmative (Y in the step S16), the flow of control returns to the step S11.

Then, processing to generate the vibration signal is performed by repeating the steps S11 through S16.

### <Processing for Derivation of the First and Second Frequency Bands>

Next, the “processing for derivation of the first and second frequency bands” in the step S13 described above will be explained.

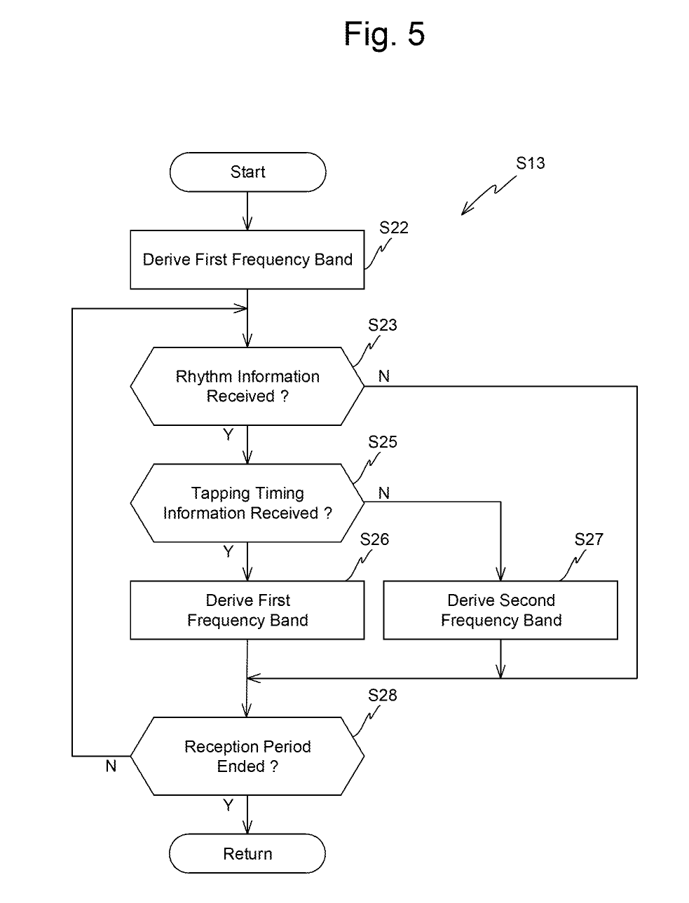

As shown in FIG. 5, in this “processing for derivation of the first and second frequency bands” first in a step S22 the derivation unit 240 determines a rhythm component detected within the predetermined time range that includes the time of reception of the tapping timing information TAP as being the characteristic rhythm component. Subsequently, on the basis of the rhythm information of the characteristic rhythm component, the derivation unit 240 derives the first frequency band in which the spectral intensity in the time zone of appearance of the characteristic rhythm component becomes equal to or greater than the predetermined value. Then the flow of control proceeds to a step S23.

In the step S23, the derivation unit 240 makes a decision as to whether or not rhythm information RTM sent from the detection unit 230 has been received. If the result of the decision is negative (N in the step S23), the flow of control is transferred to a step S28 which will be described hereinafter.

When rhythm information RTM sent from the detection unit 230 is received, so that the result of the decision in the step S23 is affirmative (Y in the step S23), then the flow of control is transferred to a step S25. In the step S25, the derivation unit 240 makes a decision as to whether or not tapping timing information TAP sent from the tapping input unit 210 has been received. If the result of the decision is affirmative (Y in the step S25), then the derivation unit 240 determines that the rhythm component of the rhythm information RTM that was acquired in the most recent processing of the step S23 is the characteristic rhythm component. Subsequently, on the basis of this rhythm information for the characteristic rhythm component, the derivation unit 240 derives the first frequency band, in which the spectral intensity in the time zone of appearance of the characteristic rhythm component becomes equal to or greater than the predetermined value. Then the flow of control is transferred to a step S28.

On the other hand, if the result of the decision in the step S25 is negative (N in the step S25), then the flow of control is transferred to a step S27. In the step S27, the derivation unit 240 determines that the rhythm component of the rhythm information RTM that was acquired in the most recent processing of the step S23 is a non-characteristic rhythm component. Subsequently, on the basis of the rhythm information for this non-characteristic rhythm component, the derivation unit 240 derives the second frequency band, in which the spectral intensity in the time zone of appearance of the non-characteristic rhythm component becomes equal to or greater than the predetermined value. Then the flow of control proceeds to the step S28.

In the step S28, by making a decision as to whether or not period information PDI to the effect that the reception period has ended has been received, the derivation unit 240 makes a decision as to whether or not the reception period has terminated. If the result of the decision is negative (N in the step S28), then the flow of control returns to the step S23.

On the other hand, when the reception period elapses and the result of the decision in the step S28 becomes affirmative (Y in the step S28), then the derivation unit 240 sets the period flag to “OFF”, and the processing of the step S13 terminates. And the flow of control is then transferred to the step S15 of FIG. 4 described above.

### <An Example of Calculation of the Third Frequency Band>

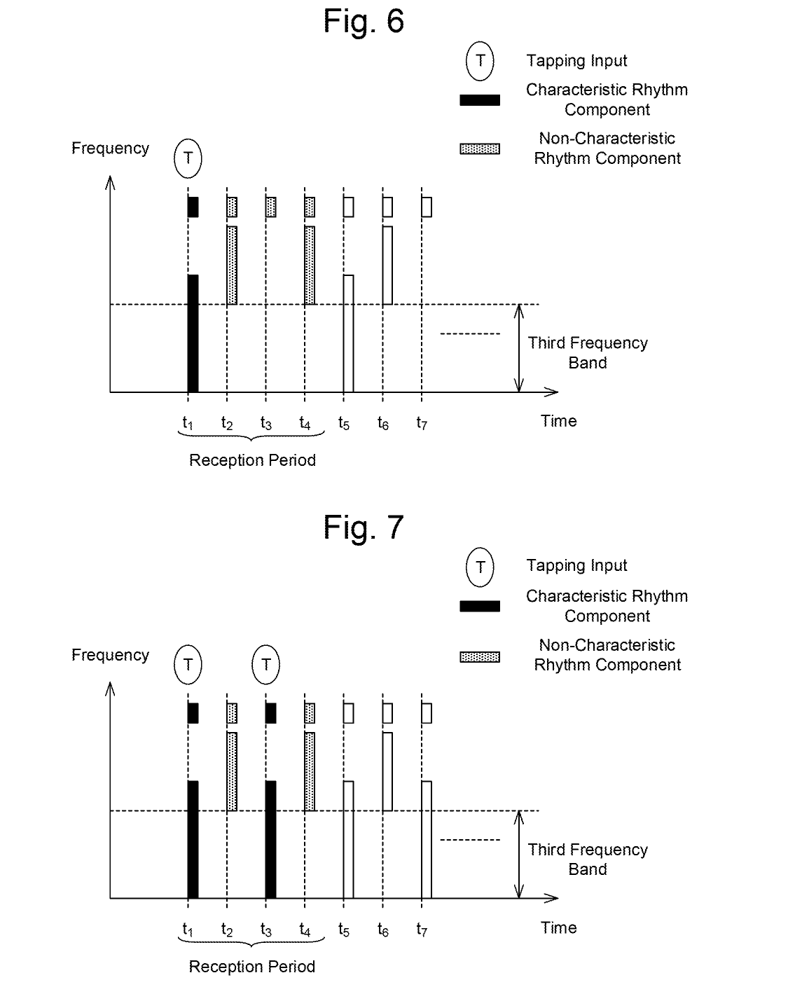

Now, an example of the relationship between the time point of appearance of a rhythm component and the tapping timing, and the third frequency band that is calculated on the basis of that relationship, will be explained with reference to FIGS. 6 through 10.

Examples of the change over time of the rhythm component for which the music signal MUD is analyzed and spectrogram information is acquired, and for which the spectral intensity is equal to or greater than the predetermined value, are shown in FIGS. 6 through 10. Here, each of the white rectangles, the black rectangles, and the gray rectangles shown in the figure represents a rhythm component for which the spectral intensity has become equal to or greater than the predetermined value.

In these examples shown in FIGS. 6 through 10, the reception period for tapping input is taken as being a time period that corresponds to four beats. Furthermore, “T” in the figure shows that tapping input has been performed, and the black boxes represent the characteristic rhythm component. Moreover, the gray boxes in the figure represent a non-characteristic rhythm component during the reception period.

In FIG. 6, an example is shown of a case in which tapping input is performed a single time during the four-beat reception period. In this example, the first frequency band becomes the frequency band occupied by the black rectangle (i.e. by the characteristic rhythm component) at the appearance time point t₁ when tapping input is performed. Moreover, in this example, the second frequency band becomes the frequency band occupied by the gray rectangles (i.e. by the non-characteristic rhythm component) at the appearance time points t₂, t₃, and t₄ when tapping input is not performed. And the third frequency band becomes “the frequency band within the first frequency band, in which the second frequency band is not included” shown in FIG. 6.

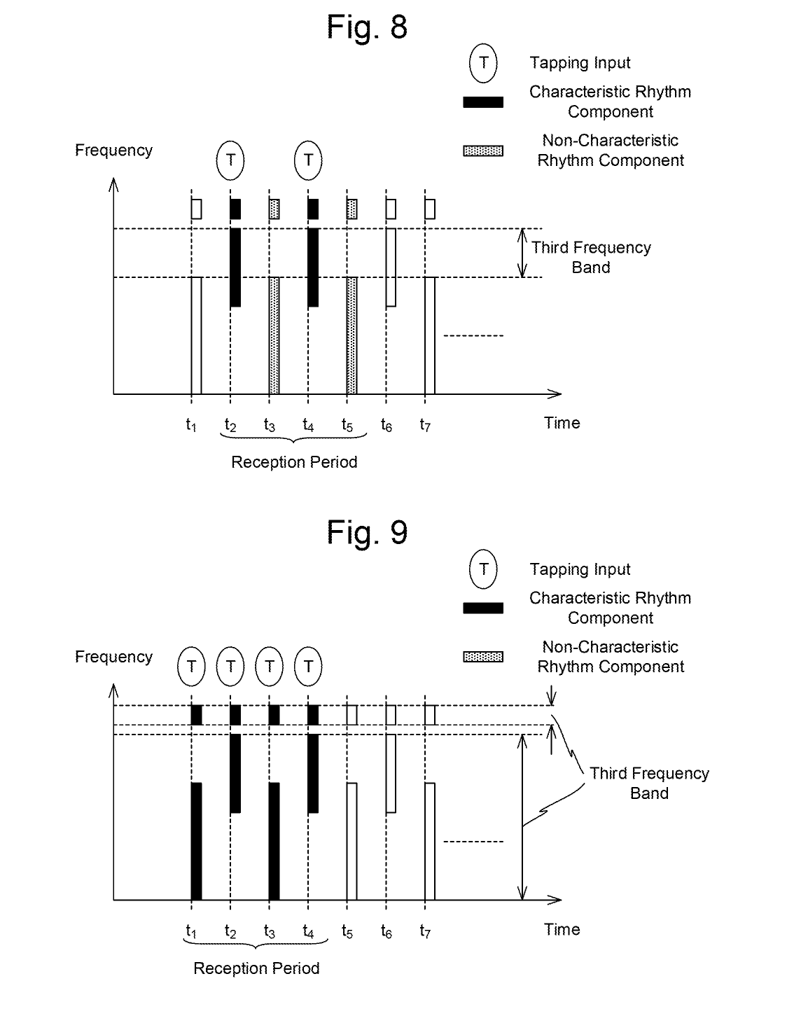

Furthermore, in FIGS. 7 and 8, examples are shown of cases in which tapping input is performed twice during the four-beat reception period. Here, the progression of the rhythm component of the musical piece is the same in FIGS. 7 and 8. And in FIG. 7 tapping input is performed at the time points t₁ and t₃ where the beat occurs, while in FIG. 8 tapping input is performed at the time points t₂ and t₄ where the backbeat occurs.

In the example of FIG. 7, the first frequency band becomes the frequency band occupied by the black rectangles (i.e. by the characteristic rhythm component) at the time points of appearance t₁ and t₃, while the second frequency band becomes the frequency band occupied by the gray rectangles (i.e. by the non-characteristic rhythm component) at the time points of appearance t₂ and t₄. And the third frequency band when the user has performed tapping input at the time point where the beat occurs becomes “the frequency band within the first frequency band, in which the second frequency band is not included” shown in FIG. 7.

Moreover, in the example of FIG. 8, the first frequency band becomes the frequency band occupied by the black rectangles (i.e. by the characteristic rhythm component) at the time points of appearance t₂ and t₄, while the second frequency band becomes the frequency band occupied by the gray rectangles (i.e. by the non-characteristic rhythm component) at the time points of appearance t₃ and t₅. And the third frequency band when the user has performed tapping input at the time point where the backbeat occurs becomes “the frequency band within the first frequency band, in which the second frequency band is not included” shown in FIG. 8.

In this manner, if the timing of the tapping input performed by the user is different even though the sound of the musical piece is the same, the third frequency band for which the music signal MUD is allowed to pass through becomes different. Due to this, it is possible to generate vibrations that are matched to the way in which each user experiences the sound of the musical piece as a whole.

Note that, in this embodiment, as shown in FIG. 7, the characteristic rhythm component appears at the time point t₁ and then the non-characteristic rhythm component appears at the time point t₂, and, even when subsequently the characteristic rhythm component appears at the time point t₃, for the frequency range where the frequency band of the characteristic rhythm component at the time point t₁ and the frequency band of the non-characteristic rhythm component at the time point t₂ are overlapped, this overlapped frequency range does not come to be included in the third frequency range, even due to the appearance of the characteristic rhythm component at the time point t₃.

Moreover, in FIG. 9, an example is shown of a case in which tapping input is performed four times during the four-beat reception period. In the example of FIG. 9, the first frequency band becomes the frequency band occupied by the black rectangles (i.e. by the characteristic rhythm component) at the time points of appearance t₁, t₂, t₃, and t₄, while the second frequency band does not exist. And the third frequency band becomes the same as the first frequency band.

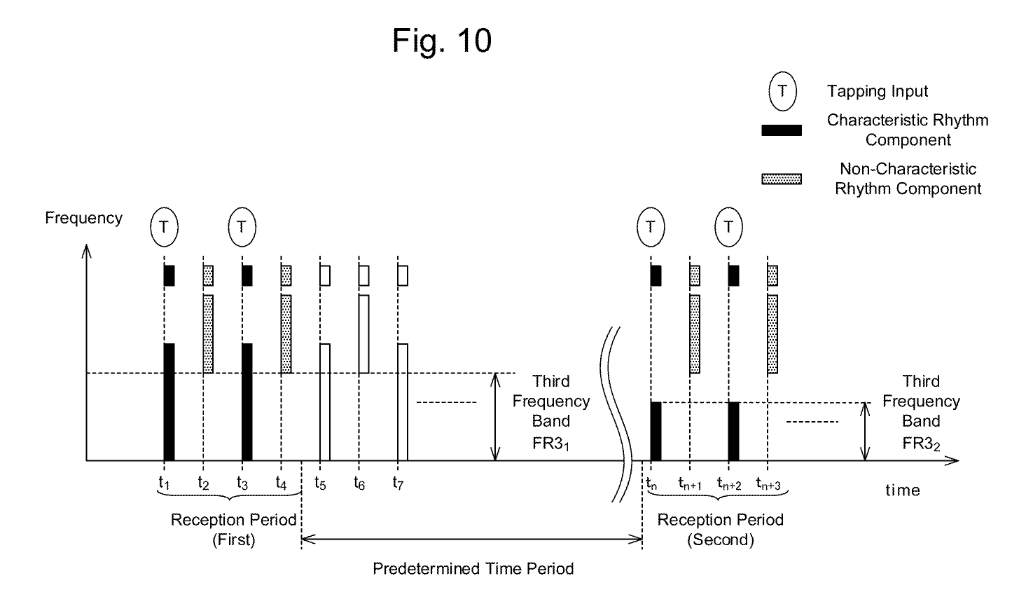

Yet further, in FIG. 10, an example is shown of a case when the predetermined time period has elapsed after the end of the first reception period, and then the second reception period has started. In the example shown in FIG. 10, the third frequency band FR3₁ that has been calculated on the basis of the tapping input in the first reception period and the rhythm component that has appeared is set as the signal pass band of the filter unit 260 until the second reception period terminates. And the third frequency band FR3₂ calculated on the basis of the tapping input in the second reception period and the rhythm component that appears is subsequently set as the signal pass band of the filter unit 260.

As has been explained above, in this embodiment, the time zone in which the detection unit 230 acquires spectrogram information by analyzing the music signal MUD, and the spectral intensity in the predetermined frequency range becomes equal to or greater than the predetermined value, is detected as being the time zone of appearance of the “rhythm” component. And the detection unit 230 generates the rhythm information RTM related to the rhythm component that has been detected, and sequentially sends that rhythm information RTM to the derivation unit 240. Moreover, upon receipt of the tapping timing information TAP sent from the tapping input unit 210, the reception period setting unit 220 starts the reception period, generates period information PDI to the effect that the current reception period is now running, and sends this period information PDI to the derivation unit 240.

And, on the basis of the tapping timing information TAP and the rhythm information RTM, the derivation unit 240 determines a rhythm component that has been detected within the predetermined time range including the time of reception of the tapping timing information TAP, as being the characteristic rhythm component of the musical piece, and derives the first frequency band in which the spectral intensity of that characteristic rhythm in its time zone of appearance becomes equal to or greater than the predetermined value. Moreover, the derivation unit 240 determines a rhythm component that has been detected outside the predetermined time range including the time of reception of the tapping timing information TAP, as being a non-characteristic rhythm component, and derives the second frequency band in which the spectral intensity of that non-characteristic rhythm in its time zone of appearance becomes equal to or greater than the predetermined value. Subsequently, the calculation unit 250 calculates the frequency band within the first frequency band in which the second frequency band is not included as being the third frequency band, and sends the pass frequency designation BPC in which the third frequency band that has thus been calculated is designated to the filter unit 260.

And the filter unit 260 performs a filtering process upon the music signal MUD while taking the frequencies designated by the pass frequency designation BPC as being the signal pass band. Subsequently, on the basis of the signal FTD that has passed through the filter unit 260, the vibration signal generation unit 270 generates the vibration signal VIS that reflects the frequency and amplitude contained in the signal FTD. And the vibration signal generation unit 270 sends this vibration signal VIS that has thus been generated to the vibration unit 400.

Due to this, the user is able to set his desired rhythm easily, and his sense of unity of the musical piece can be enhanced due to his sensing this rhythm by vibration. Moreover, it also becomes possible to obtain a sense of unity corresponding to a rhythmic component other than that of a percussion instrument, such as hand clapping or the like.

Moreover, in this embodiment, when the predetermined time period elapses from the end of the reception period and then tapping timing information TAP sent by the tapping input unit 210 is received, the reception period setting unit 220 starts a new reception period. And the derivation unit 240 and the calculation unit 250 cooperate to calculate the new third frequency band, and the pass frequency designation BPC that designates the new third frequency band is sent to the filter unit 260.

Due to this, even if the tempo or the pattern of the musical piece changes partway through, or if the rhythm component that matches the sense of rhythm of the user changes in accordance with the progression of the musical piece, still it is possible to generate vibrations that are matched to the feeling of the musical piece as experienced by the user.

Thus, according to this embodiment, in accordance with the progression of the musical piece, it is possible to generate vibrations that are matched to the way in which each user experiences the sound of the musical piece as a whole, so that it is possible to impart to each individual user a sense of unity between the vibrations and the sound of the musical piece.

### Modification of Embodiment

The present invention is not to be considered as being limited to the embodiment described above; modifications of various kinds are possible to implement thereto.

For example, in the embodiment described above, it is arranged for the vibration signal generating unit to generate a vibration signal that reflects the frequency and the amplitude of the signal passed through the filter unit. By contrast, it would also be acceptable to arrange to include the input intensity when tapping input is performed in the tapping timing information, and for the vibration signal generating unit to generate its vibration signal in accordance, not only with the frequency and the amplitude of the signal that has passed through the filter unit, but also with this tapping input intensity in the tapping timing information.

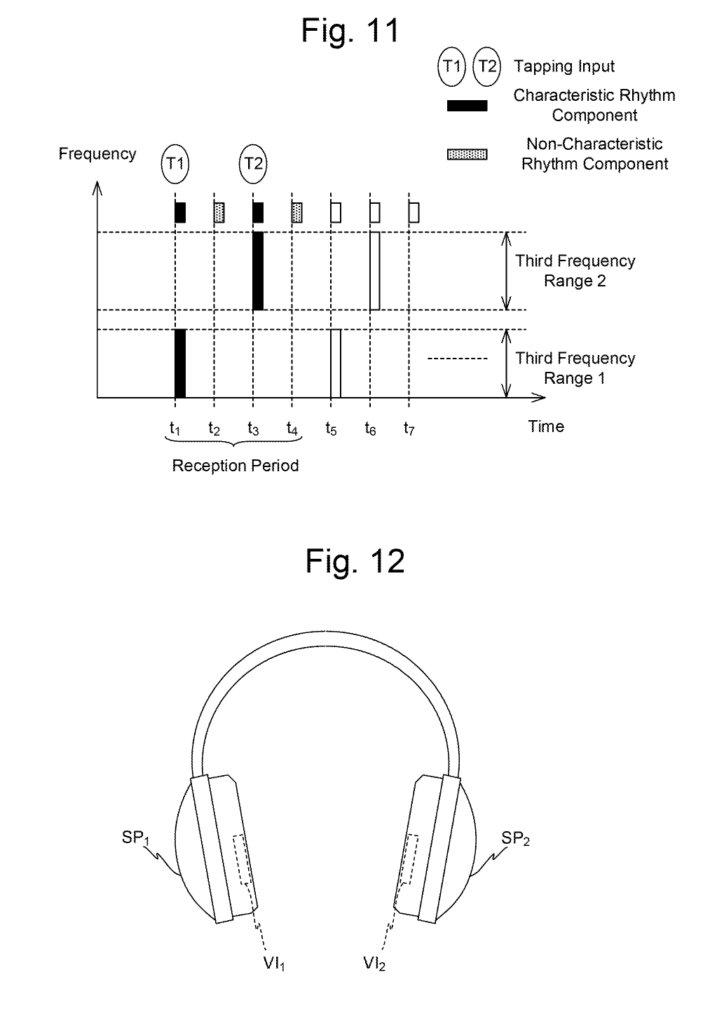

With a configuration of this type being employed, if tapping input is performed twice, and if a “third frequency range 1” that is calculated on the basis of the tapping input “T1” the first time and a “third frequency range 2” that is calculated on the basis of the tapping input “T2” the second time are different from one another as shown for example in FIG. 11, then it would be acceptable to arrange to generate the vibration signal in the following manner.

The signal that has passed through the filter unit to which the “third frequency range 1” is designated and that has been converted from digital to analog will be termed FTS1, and the signal that has passed through the filter unit to which the “third frequency range 2” is designated and that has been converted from digital to analog will be termed FTS2. Moreover, the input intensity during the tapping input “T1” will be termed “TS1”, and the input intensity during the tapping input “T2” will be termed “TS2”. And the vibration signal VIS may be created according to the following Equation (1):

VIS=FTS1×TS1+FTS2×TS2 (1)

Furthermore while, in the embodiment described above, it was arranged to receive timings from the user related to the rhythm by tapping input, it would also be acceptable, for example, to arrange to receive such timings from the user related to the rhythm by detecting the voice of the user or his handclapping with a microphone.

Yet further, it would also be possible to dispose the sound device, the speakers, and the vibrators of the embodiment described above in the interior of a building, or to dispose them in the interior of a vehicle.

Furthermore, in the embodiment described above, it was arranged to dispose the speakers in front of the seat, and to dispose the vibrators in the seat. By contrast, as shown in FIG. 12, it would also be acceptable to build the speakers SP₁ and SP₂ as headphone speakers, and to dispose the vibrators VI₁ and VI₂ in the interiors of left and right ear contact members of these headphones. Moreover, it would also be acceptable to dispose the vibrators in the interiors of earphones. Note that, if this type of configuration relationship of the speakers and the vibrators is employed, then the sound device could be one that is disposed in a fixed configuration in a house or a car or the like, or could be one that can be carried by the user.

Moreover while, in the embodiment described above, it was arranged for the sound device to be provided with the vibration signal generation apparatus, it would also be acceptable to provide a configuration in which vibrations are transmitted to an audience in a disco or a club by a so-called disk jockey (DJ) operating a plurality of players and/or mixers or the like so as to perform tapping input action. Moreover, it would also be possible to provide a configuration in which, in a dance lesson, an instructor performs tapping input action, thus imparting vibrations to students in the dance lesson.

Even further, it would also be acceptable to provide a configuration in which information related to a frequency band extracted from the sound of a musical piece (i.e. to the third frequency band) that has been obtained according to tapping input by one user is transmitted to an external server device, so that this information related to the aforesaid extracted frequency band can also be employed by other users.

Note that it would also be possible to arrange to build a portion or all of the vibration signal generation apparatus described above as a calculation means that is provided with a central processing device (CPU: Central Processing Unit) or the like, and to implement the function of the vibration signal generation apparatus in the embodiments described above by executing a program upon that computer that has been prepared in advance. This program may be recorded upon a recording medium that can be read by a computer, such as a hard disk, a CD-ROM, a DVD or the like, and is read out by the above computer from the recording medium and executed. Moreover, it would be possible to arrange for this program to be acquired in the state of being recorded upon a transportable recording medium such as a CD-ROM, a DVD or the like; or it would also be possible to arrange for the program to be acquired in the form of distribution via a network such as the internet or the like.

1-11. (canceled)

12. A vibration signal generation apparatus, comprising:
a detection unit that detects a rhythm of a musical piece;
a reception unit that receives input of timing information from a user; and
a generation unit that generates a vibration signal for causing a vibration unit to vibrate, using a signal for a signal pass band that is obtained on the basis of a first frequency band and a second first frequency band for determining the signal pass band as a third frequency band; wherein,
the first frequency band has a spectral intensity equal to or greater than a predetermined value at a time point of appearance of a characteristic rhythm, which is defined as a rhythm detected by said detection unit within a predetermined time range, including a time point at which said reception unit has received said input of timing information, and
the second frequency band has the spectral intensity equal to or greater than the predetermined value said predetermined value at a time point of appearance of a non-characteristic rhythm, which is different from the characteristic rhythm and is defined as a rhythm detected by said detection unit within a predetermined reception period.

13. The vibration signal generation apparatus according to claim 12, wherein:
said detection unit acquires spectrogram information that shows a change over time of a frequency characteristic of said musical piece, and, on the basis of said spectrogram information that has been acquired, detects a time point at which, in a predetermined frequency range, the spectral intensity becomes equal to or greater than said predetermined value, as being the time point of appearance of said rhythm; and
said generation unit performs processing that includes a filtering process, and, on the basis of a frequency characteristic at the time point of appearance of said characteristic rhythm and a frequency characteristic at the time point of appearance of said non-characteristic rhythm, sets said third frequency band to the signal pass band for said filtering process for passing through a signal component of said musical piece, and generates said vibration signal on the basis of the signal after said filtering process has been performed.

14. The vibration signal generation apparatus according to claim 13, wherein, said generation unit comprises:
a derivation unit that derives said first frequency band and said second frequency band; and
a calculation unit that calculates a frequency band in said first frequency band in which said second frequency band is not included as being said third frequency band.

15. The vibration signal generation apparatus according to claim 14, wherein, upon receipt of input of a plurality of items of timing information in said reception period, for each appearance time point of said rhythm, said generation unit determines which of a time point of appearance of said characteristic rhythm and a time point of appearance of said non-characteristic rhythm this appearance time point is, and calculates said third frequency band.

16. The vibration signal generation apparatus according to claim 15, wherein, during an interval other than said reception period, said reception unit starts said reception period upon receipt of said timing information from the user.

17. The vibration signal generation apparatus according to claim 16, wherein, said reception unit star is a new reception period upon receipt of said timing information from the user after a predetermined time period has elapsed from the end of said reception period.

18. The vibration signal generation apparatus according to claim 12, wherein, the input intensity during input of information is included in said timing information, and in that said generation unit generates a vibration signal according to said input intensity.

19. A vibration signal generation method employed by a vibration signal generation apparatus that comprises a detection unit, a reception unit, and a generation unit, and that generates a vibration signal, comprising the steps of:
a detection step in which said detection unit detects a rhythm of a musical piece;
a reception step in which said reception unit receives input of timing information from a user; and
a generation step in which said generation unit generates a vibration signal for causing a vibration unit to vibrate, using a signal for a signal pass band that is obtained on the basis of a first frequency band and a second frequency band; wherein,
the first frequency band has a spectral intensity equal to or greater than a predetermined value at a time point of appearance of a characteristic rhythm, which is defined as a rhythm detected by said detection unit within a predetermined time range, including a time point at which said reception unit has received said input of timing information, and
the second frequency band has the spectral intensity equal to or greater than the predetermined value said predetermined value at a time point of appearance of a non-characteristic rhythm, which is different from the characteristic rhythm and is defined as a rhythm detected by said detection unit within a predetermined reception period.

20. A non-transient computer readable medium having recorded thereon a vibration signal generation program that, when executed, causes a computer in a vibration signal generation apparatus that generates a vibration signal to execute the vibration signal generation method according to claim 19.
